(19) United States
(12) Patent Application Publication
(10) Pub. No.: US 2025/0084342 A1
(43) Pub. Date: Mar. 13, 2025

(54) ACIDIC BATHROOM AND/OR MULTI-PURPOSE CLEANER WITHOUT CORROSION INHIBITOR

(71) Applicant: S.C. JOHNSON & SON, INC., Racine, WI (US)

(72) Inventors: Michael D. LaBelle, Muskego, WI (US); Steven J. Suess, Racine, WI (US)

(73) Assignee: S.C. JOHNSON & SON, INC., Racine, WI (US)

(21) Appl. No.: 18/830,889

(22) Filed: Sep. 11, 2024

Related U.S. Application Data
(60) Provisional application No. 63/537,897, filed on Sep. 12, 2023.

(51) Int. Cl. C11D 3/00; C11D 1/66; C11D 1/83; C11D 3/20

(52) U.S. Cl. CPC C11D 3/0073; C11D 1/662; C11D 1/83; C11D 3/2075; C11D 2111/14

(57) ABSTRACT

An acidic bathroom and/or multi-purpose cleaner providing corrosion protection in the absence of a corrosion inhibitor when present in a metal container, such as an aluminum container, is described. The corrosion protection is provided by the inclusion in the cleaner of a combination of one or more organic acids and one or more anionic surfactants present in the cleaner. The cleaner has a pH equal to or less than 3. The cleaner may also include a nonionic surfactant and has an aqueous carrier, such as purified water. The cleaner can be an aerosol or a non-aerosol cleaner.

### RELATED APPLICATION

The present application claims benefit of U.S. Provisional Application Ser. No. 63/537,897 filed Sep. 12, 2023, which is incorporated herein by reference.

### FIELD OF THE INVENTION

The invention is directed to cleaners, in particular bathroom and/or multi-purpose cleaners, which are acidic, do not include a corrosion inhibitor, and provide protection against corrosion during the product life of the cleaner when the cleaner is stored in and dispensed from a metal container, including an aluminum container. The cleaner may be a non-aerosol or aerosol cleaner product.

### BACKGROUND OF THE INVENTION

Bathroom and multi-purpose cleaners generally have an acidic pH and are contained in metal containers, such as steel or aluminum containers, for storage and for dispensing as a spray or foam. Aluminum is normally prone to corrosion when in contact with an acidic cleaner having a pH outside a range of 4-7. To protect the metal of the container throughout the life of the cleaner product, one or more corrosion inhibitors are included in conventional cleaners, for example alkali metal phosphates and/or alkali metal sulfates. The inclusion of one or more corrosion inhibitors, however, adds to the cost of the product and does not contribute to the cleaning ability of the cleaner.

Accordingly, it would be beneficial to provide an acidic bathroom and/or multi-purpose cleaner not requiring inclusion of a corrosion inhibitor, and which is not corrosive to a metal dispensing container, especially an aluminum dispensing container.

### SUMMARY OF THE INVENTION

An acidic bathroom and/or multi-purpose cleaner (also known as an all-purpose cleaner) (hereafter “cleaner” or “cleaner product”) is provided which is compatible with a metal, preferably aluminum, dispensing container in the absence of a corrosion inhibitor.

The acidic cleaner has a pH equal to or less than 3, preferably less than 3, and includes one or more anionic surfactants in combination with one or more organic acids to provide corrosion protection for a metal container in which the cleaner is stored and dispensed from during the product life of the cleaner. The metal container, thus, has long term stability.

Another benefit without being bound by theory is that the cleaner will include lower corrosion rates on metal surfaces treated with the cleaner, e.g., metal bathroom fixtures.

A preferred formulation for an acidic bathroom and/or multi-purpose cleaner includes an aqueous carrier, e.g., water; one or more organic acids, preferably citric acid; one or more anionic surfactants, preferably one or more alkali metal alkyl benzene sulfonates; a nonionic surfactant, preferably one or more ethoxylated alcohols; and one or more adjuvants, e.g., a fragrance. The cleaner is preferably dispensed as an aerosol cleaner and, thus, also includes a propellant. The propellant can be a liquified petroleum gas (LPG) or a compressed gas propellant. The cleaner can also be dispensed from an aluminum container as a non-aerosol using a trigger spray mechanism. The nozzle structure of the aerosol or non-aerosol embodiments will determine whether the cleaner is dispensed as a liquid spray or a foam.

### DETAILED DESCRIPTION OF THE INVENTION

The invention is directed to an acidic bathroom and/or multi-purpose cleaner which is suitable for storage in and dispensing from a metal container, such as an aluminum or steel container, in the absence of the inclusion in the cleaner of a corrosion inhibitor. The cleaner has a pH equal to or less than 3 and yet is not prone to corroding the metal container in which the cleaner is stored and dispensed from. Corrosion on the interior surface of metal containers generally manifests itself in pitting of the interior surface of the container.

The combination of components in the cleaner which provides corrosion protection, i.e., no or minimal interior corrosion of the metal container, is the combination of one or more anionic surfactants present in the cleaner formulation with one or more organic acids present in the cleaner. “Minimal interior corrosion” is understood to be corrosion which does not interfere with the product life of the container and which does not result in discoloration of the cleaner or degradation of the cleaner properties.

The components of the cleaner are based on 100 weight percent (wt. %) and are based on the wt. % of the component itself as included in the cleaner and not on the actives of the component. Any sub-range within a given described range is understood to also be applicable to obtaining the desired cleaner.

Examples of anionic surfactants suitable for use in the cleaner are alkali metal alkyl benzene sulfonates, preferably sodium dodecyl benzene sulfonate and/or sodium xylene sulfonate; alpha olefin sulfonates; PC48-sulfolaurate; sodium alkyl sulfates, preferably sodium lauryl sulfate; sodium alkyl ether sulfates, preferably sodium lauryl ether sulfate; and C14-C17 alkyl sec-sulfonates. The one or more anionic surfactants are present in an amount of about 0.05 to about 5.00 wt. %, preferably about 0.10 to about 1.00 wt. %, and more preferably about 0.25 to about 0.57 wt. %.

Examples of organic acids suitable for use in the cleaner are citric acid, lactic acid, glycolic acid, and buffered solutions of acetic acid, sulfuric acid, sulfamic acid, hydrochloric acid, and peroxyacetic acid. The preferred acid is citric acid. The organic acid is present in an amount of about 0.01 to about 10.00 wt. %, preferably about 0.01 to about 3.00 wt. %, and more preferably about 2.00 to about 2.89 wt. %.

The cleaner preferably also includes a nonionic surfactant to aid in providing the desired cleaning effect. Nonionic surfactants suitable and preferred for inclusion are alkyl ethoxylated alcohols, such as C9-C11 ethoxylated alcohols; and alkyl polyglucosides. The nonionic surfactant is present in an amount of about 0.00 to about 5.00 wt. %, preferably about 0.20 to about 3.00 wt. %, and more preferably about 0.40 to about 1.75 wt. %.

The cleaner includes an aqueous carrier such as water. The water preferably is purified water, such as deionized water, reverse osmosis water, distilled water, and the like.

Propellants suitable for use when the cleaner is to be dispensed from an aerosol metal container can be a liquid or liquified petroleum gas (LPG), such as hydrocarbon (e.g., isobutane, butane, propane, and mixtures thereof), dimethyl ether, methyl ethyl ether, etc. as conventionally known for use. Isobutane is the preferred LPG. The propellant can also be one or more compressed gas propellants, for example, nitrogen, air, carbon dioxide, nitrous oxide, argon, or mixtures thereof. The one or more propellants are present in the cleaner product in an amount of about 0.4 to about 30.0 wt. % based on the total aerosol formula composition. LPG propellants are present preferably in a range of about 3 wt. % to about 6 wt. %. Compressed gas propellants are usually present in a lower amount so that the container is filled to about 128 to about 150 PSI (pounds per square inch), preferably to about 138 PSI.

Adjuvants which do not affect the desired features of the inventive cleaner can be present in an amount of less than 0.2 wt. %. A preferred adjuvant is a fragrance (which is understood to include one or a mixture of fragrances or perfumes which impart a desired scent). Conventional fragrance components suitable for use are well known to those skilled in the art and, accordingly, are not described in detail here.

A preferred present embodiment of the inventive acidic bathroom and/or multi-purpose cleaner providing corrosion protection when contained in a metal, especially an aluminum, container while excluding a corrosion inhibitor therein is set forth in Table 1 below.

TABLE 1

| INGREDIENTS | WT. % |
|---|---|
| Purified Water | 91.81435 |
| Citric Acid (50% actives) (liquid) | 5.7894 |
| Sodium Dodecyl Benzene Sulfonate | 0.4 |
| (anionic surfactant) (DDBSA) | |
| Sodium Xylene Sulfonate (40%) | 0.14625 |
| (anionic surfactant) (SXS) | |
| C9-C11 Ethoxylated Alcohols | 1.75 |
| (nonionic surfactant) | |
| Fragrance | 0.1 |
| TOTAL | 100% |

As noted above, the cleaner can include a propellant in a metal storage and dispensing container, or be dispensed using a trigger dispenser. Using a conventional packaging arrangement, when a LPG is used as the propellant, a foaming product is provided. The use of nitrogen or like propellant creates a light mist product or a foam depending on the dispensing head used as conventionally known in the art.

Preferred alternative pairings of an anionic surfactant and organic acid according to the invention are lactic acid and alpha olefin sulfonate; glycolic acid and sodium xylene sulfonate; acetic acid and PC48-sulfolaurate; sulfuric acid and sodium lauryl sulfate; and sulfamic acid and sodium lauryl ether sulfate. The pairing of lactic acid and alpha olefin sulfonate is preferably further combined with an alkyl polyglucoside nonionic surfactant.

Comparative test samples showing the corrosion protection provided by the acidic cleaner of the invention is set forth in Table 2 below.

TABLE 2

| | | | | CORROSION |
|---|---|---|---|---|
| TEST | | | | RATE |
| SAMPLE # | ACID | SURFACTANT | pH | (mil/yr) |
| (1) | Lactic Acid | Nonionic only | 6.01 | 1.4-2.1 |
| (2) | Lactic Acid | Nonionic only | 5.01 | 1.7-2.6 |
| (3) | Lactic Acid | Nonionic only | 4.00 | 1.7 |
| (4) | Lactic Acid | Nonionic only | 2.99 | 1.9-2.1 |
| (5) | Lactic Acid | Anionic blend | 3.00 | 0.3 |
| | | & Nonionic | | |
| (6) | Citric Acid | Anionic blend | 1.90 | 0.3 |
| | | & Nonionic | | |

Test data has also shown that the combination of concentrations of 10 wt. % citric acid with 1-5 wt. % sodium dodecyl benzene sulfonate (DDBSA) significantly reduces pitting potential to interior surfaces of an aluminum container. A preferred combination is about 2.9 wt. % citric acid with 0.4 wt. % of DDBSA to significantly reduce pitting potential. These test samples were calculated in molar ratios of citric acid:DDBSA, i.e., 2.9 wt. % citric acid:DDBAS (15.1:0.43); and 10 wt. % citric acid:DDBAS (52.05:1.06).

The exemplary embodiments disclosed herein are not intended to be exhaustive or to unnecessarily limit the scope of the invention. The exemplary embodiments were chosen and described to explain the principles of the present invention so that others skilled in the art may practice the invention. As will be apparent to one skilled in the art, various modifications can be made within the scope of the aforesaid description. Such modifications being within the ability of one skilled in the art form a part of the present invention.

It is noted that terms like “specifically”, “preferably”, “typically”, “generally”, and “often” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

The values and ranges disclosed herein are not to be understood as being strictly limited to the exact numerical values recited. Instead, unless otherwise specified, each such value is intended to mean both the recited value and a functionally equivalent range surrounding that value. For example, a value disclosed as “10 wt. %” is intended to mean “about 10 wt. %.” Any range described herein includes any and all sub-ranges within the ranges recited even if not specifically named.

1. An acidic bathroom and/or multi-purpose cleaner comprising
(a) one or more organic acids;
(b) one or more anionic surfactants;
(c) optionally, one or more nonionic surfactants;
(d) optionally, one or more fragrances;
(e) optionally, a propellant component; and
(f) an aqueous carrier;
wherein a corrosion inhibitor is excluded from the acidic bathroom and/or multi-purpose cleaner,
wherein the cleaner has a pH equal to or less than 3, and
wherein the cleaner provides corrosion protection to interior surfaces of a metal container when the cleaner is stored in the metal container.

2. A combination product comprising
(1) an acidic bathroom and/or multi-purpose cleaner including
(a) one or more organic acids;
(b) one or more anionic surfactants;
(c) optionally, one or more nonionic surfactants;
(d) optionally, one or more fragrances;
(e) optionally, a propellant component; and
(f) an aqueous carrier;
wherein a corrosion inhibitor is excluded from the acidic bathroom and/or multi-purpose cleaner, and
wherein the cleaner has a pH equal to or less than 3; and
(2) a metal container in which said bathroom and/or multi-purpose cleaner is stored and dispensed from in use, wherein the cleaner reduces corrosion of interior surfaces of the metal container when the cleaner is stored in the metal container.

3. The cleaner according to claim 1, wherein said one or more organic acids is present in an amount of about 0.01 to about 10 wt. %, and said one or more anionic surfactants is present in an amount of about 0.05 to about 5 wt. %.

4. The combination product of claim 2, wherein said cleaner includes said one or more organic acids in an amount of about 0.01 to about 10 wt. %, and includes said one or more anionic surfactants in an amount of about 0.05 to about 5 wt. %.

5. The cleaner of claim 1, wherein said one or more acids is one or more of citric acid; lactic acid; glycolic acid; and buffered solutions of acetic acid, sulfuric acid, sulfamic acid, hydrochloric acid, and peroxyacetic acid.

6. The combination product of claim 2, wherein said one or more acids is one or more of citric acid; lactic acid; glycolic acid; and buffered solutions of acetic acid, sulfuric acid, sulfamic acid, hydrochloric acid, and peroxyacetic acid.

7. The cleaner of claim 1, wherein said one or more anionic surfactants is one or more of alkali metal alkyl benzene sulfonates, alpha olefin sulfonates, PC48-sulfolaurate, sodium alkyl sulfates, sodium alkyl ether sulfates, and C14-C17 alkyl sec-sulfonates.

8. The combined product of claim 2 wherein said one or more anionic surfactants is one or more of alkali metal alkyl benzene sulfonates, alpha olefin sulfonates, PC48-sulfolaurate, sodium alkyl sulfates, sodium alkyl ether sulfates, and C14-C17 alkyl sec-sulfonates.

9. The cleaner of claim 1, wherein said one or more nonionic surfactants is present in the cleaner.

10. The combined product of claim 2 wherein said one or more nonionic surfactants is present in the cleaner.

11. The cleaner of claim 9, wherein the one or more nonionic surfactants is present in an amount of greater than 0 to about 5 wt. %.

12. The combined product of claim 10, wherein the one or more nonionic surfactants is present in an amount of greater than 0 to about 5 wt. %.

13. The cleaner of claim 1, wherein the propellant component is present and is one of a liquid or liquified petroleum gas (LPG), dimethyl ether, methyl ethyl ether, or one or more compressed gas.

14. The combined product of claim 2, wherein the propellant component is present and is one of a liquid or liquified petroleum gas (LPG), dimethyl ether, methyl ethyl ether, or one or more compressed gas.

15. The cleaner of claim 1, wherein the metal container is an aluminum container.

16. The combined product of claim 2, wherein the metal container is an aluminum container.

17. The cleaner of claim 1, wherein the one or more acids and the one or more anionic surfactants include one of the following pairings-sodium dodecyl benzene sulfonate, sodium xylene sulfonate and citric acid; lactic acid and alpha olefin sulfonate; glycolic acid and sodium xylene sulfonate; acetic acid and PC48-sufolaurate; sulfuric acid and sodium lauryl sulfate; and sulfamic acid and sodium lauryl ether sulfate.

18. The combined product of claim 2, wherein the one or more acids and the one or more anionic surfactants include one of the following pairings-sodium dodecyl benzene sulfonate, sodium xylene sulfonate and citric acid; lactic acid and alpha olefin sulfonate; glycolic acid and sodium xylene sulfonate; acetic acid and PC48-sufolaurate; sulfuric acid and sodium lauryl sulfate; and sulfamic acid and sodium lauryl ether sulfate.

19. The cleaner of claim 1, wherein said one or more acids is lactic acid, the one or more anionic surfactants is alpha olefin sulfonate, and said one or more nonionic surfactants is present and is an alkyl polyglucoside.

20. The combined product of claim 2, wherein said one or more acids is lactic acid, the one or more anionic surfactants is alpha olefin sulfonate, and said one or more nonionic surfactants is present and is an alkyl polyglucoside.

21. An acidic bathroom and/or multi-purpose cleaner comprising
(a) one or more organic acids which includes citric acid;
(b) one or more anionic surfactants which includes sodium dodecyl benzene sulfonate and sodium xylene sulfonate;
(c) one or more nonionic surfactants which includes a C9-C11 ethoxylated alcohol;
(d) optionally, one or more fragrances;
(e) optionally, a propellant component; and
(f) a carrier which includes water;
wherein a corrosion inhibitor is excluded from the acidic bathroom and/or multi-purpose cleaner,
wherein the cleaner has a pH equal to or less than 3, and
wherein the cleaner provides corrosion protection to interior surfaces of a metal container when the cleaner is stored in the metal container.

22. A combination product comprising
(1) an acidic bathroom and/or multi-purpose cleaner including
(a) one or more organic acids which includes citric acid;
(b) one or more anionic surfactants which includes sodium dodecyl benzene sulfonate and sodium xylene sulfonate;
(c) one or more nonionic surfactants which includes a C9-C11 ethoxylated alcohol;
(d) optionally, one or more fragrances;
(e) optionally, a propellant component; and
(f) a carrier which includes water;
wherein a corrosion inhibitor is excluded from the acidic bathroom and/or multi-purpose cleaner, and
wherein the cleaner has a pH equal to or less than 3; and
(2) a metal container in which said bathroom and/or multi-purpose cleaner is stored and dispensed from in use, wherein the cleaner reduces corrosion of interior surfaces of the metal container when the cleaner is stored in the metal container.

23. The cleaner of claim 21, wherein the metal container is an aluminum container.

24. The combined product of claim 22, wherein the metal container is an aluminum container.
